(19) United States
(12) Patent Application Publication
(10) Pub. No.: US 2015/0222436 A1
(43) Pub. Date: Aug. 6, 2015

(54) TECHNIQUES FOR SECURING NETWORKED ACCESS SYSTEMS

(71) Applicant: Nagravision S.A., Cheseaux-Sur-Lausanne (CH)

(72) Inventor: Glenn Morten, Bellevue, WA (US)

(73) Assignee: NAGRAVISION S.A., Cheseaux-Sur-Lausanne (CH)

(21) Appl. No.: 14/174,801

(22) Filed: Feb. 6, 2014

(51) Int. Cl. H04L 9/32; H04L 9/14

(52) U.S. Cl. CPC H04L 9/3247; H04L 9/3223; H04L 9/14; H04L 2209/24; H04L 2209/72

(57) ABSTRACT

A system for controlling access to a facility such as a parking structure includes an access device that operates a physical barrier that controls access and a controller that communicates with the access device via a communication network to control the operation of the access device. Messages exchanged between the controller and the access device are secured by encrypting the messages using a first private key and by encrypting a hash value of the encrypted message with a second private key.

### BACKGROUND

This document relates to secure electronic communication and controlling physical access to a facility.

Access to facilities can be controlled by a physical barrier such as a gate or a bar whose operation is controlled by a control computer. Such access-controlled facilities include various premises and structures, including public facilities, private facilities, parking structures and others.

### SUMMARY

The present document discloses techniques for securing the remote operation of a physical barrier for restricting entry or exit of a premise or facility. With the ubiquitous availability of communication networks such as the Internet, the physical barrier can be operated by communicating with one or more control computers or processors.

In one aspect a technique for securing message communication for controlling access to a facility includes generating a command, wherein the command specifies an action to be performed by an access mechanism to the facility, producing a complete command by adding a message number and a nonce to the command, generating an encrypted complete command by encrypting the complete command using a first private key, computing a hash of the encrypted complete command, calculating a digital signature by encrypting the hash using a second private key, and transmitting the encrypted complete command and the digital signature using a transmission protocol.

In another aspect, an apparatus for controlling access to a facility includes a network module that receives an encrypted complete command and a digital signature, a signature verification module that calculates a digital signature by decrypting the encrypted complete command using a first public key, a hash matching module that matches a hash of the encrypted complete command, a decryption module that generates a decrypted complete command by decrypting the complete command using a second public key, a message filter module that produces a complete command by removing a message number and a nonce to the command, and a command execution module that executes the command, wherein the command specifies an action to be performed by an access mechanism to the facility.

In yet another aspect, a system for securing access to a facility includes an access device that operates a physical barrier that controls access to the facility and a controller that is located remotely from the access device and controls operation of the access device by transmitting operation commands to the access device. The controller transmits an operation command by encrypting a command code by a first private key, calculating a hash value of the encrypted command code, signing the hash value by a second private key and including the encrypted command code and the signed hash value in the transmission. The access device receives the transmission, extracts the operation command, and upon successful extraction of the operation command, operates the physical barrier according to the operation command.

These, and other, aspects are described below in the drawings, the description and the claims.

### BRIEF DESCRIPTION OF THE DRAWINGS

FIG. 1 depicts example architecture of a public access system.

FIG. 2 depicts example architecture of a public access system that can be remotely controlled.

FIG. 3 depicts example architecture of a secured public access system that can be remotely controlled.

FIG. 4 is a flowchart of an example method of securing communication messages that control a public access system.

FIG. 5 is a flowchart of an example method of processing secure communication messages at a public access system.

FIG. 6A is a flowchart representation of an example method for allowing access to a facility.

FIG. 6B is a flowchart representation of an example method for allowing exit from a facility.

FIG. 6C is a flowchart representation of an example method for monitoring the status of a physical barrier.

FIG. 7 is a flowchart representation of an example process of controlling access to applications on a user device.

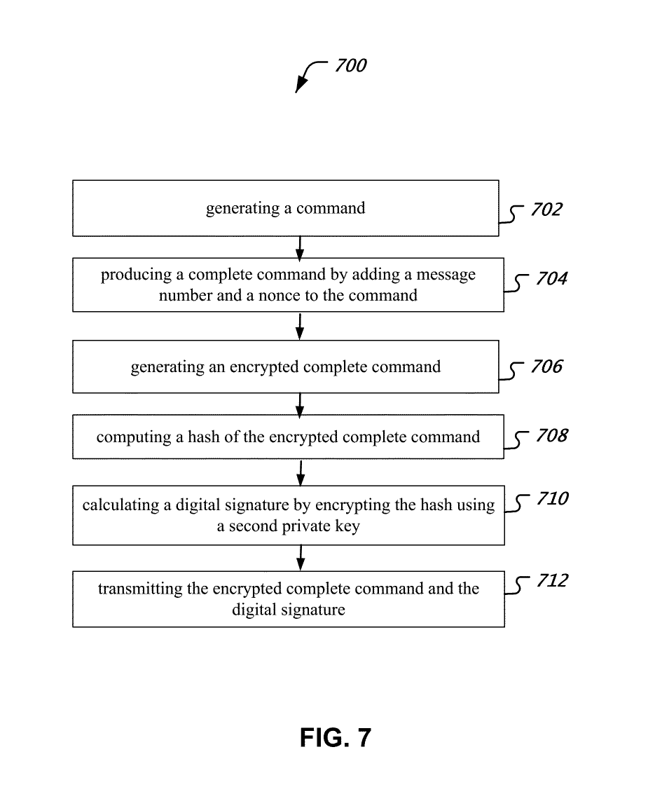

FIG. 8 depicts an example apparatus for controlling access to applications on a user device.

Like reference symbols in the various drawings indicate like elements.

### DETAILED DESCRIPTION

Access to a facility or premise can be controlled by a physical barrier. Examples of such a facility or premise include public places such as buildings, gated areas or locations and parking lots. The physical barrier may be operated by an electromechanical mechanism that is controlled to open or close a physical barrier. Examples of such mechanisms include a sliding gate, a swiveling gate, a bar that can be raised and brought down, spikes in the ground, latches or locks on doors, etc.

Various controlled access systems like parking gates have functioned in a standalone mode or within an isolated network. In some implementations, for example, the controller that controls the physical barrier is often co-located with the physical barrier. A hacker can hack such a system by gaining physical access to the control computer at the access controlled facility.

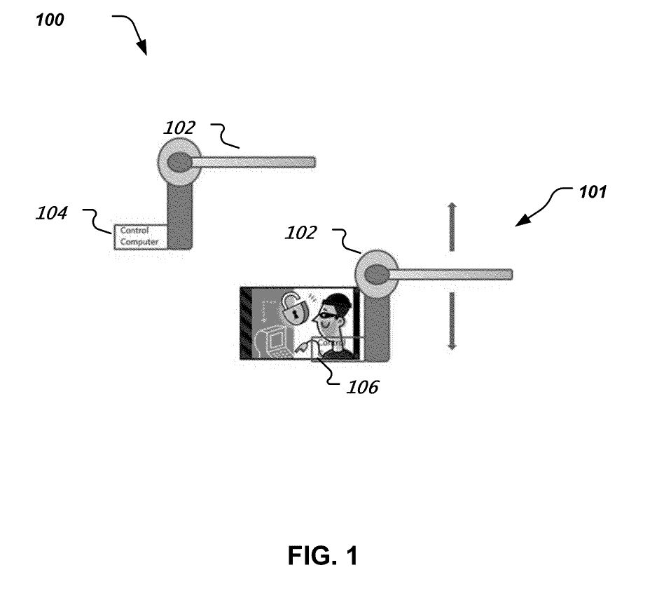

FIG. 1 depicts an example of a public access system 100 where an electronically actuated bar 102 for restricting the access is controlled by a controller 104 such as a computer co-located with the bar 102 on site. The controller 104 is typically located in the proximity of the bar 102 and controls the up/down movement of the bar 102. As depicted in 101, for circumventing the security of the system 100, a potential attacker/hacker 106 may need to be at the location, in the close proximity of the control computer 104. In such a situation, the attacker 106 could be easily noticed and any malicious tampering can be prevented by physical intervention by the premise security personnel or law enforcement personnel. As a result, no consideration has been given to attacks or spoofing of the control component of the public access systems.

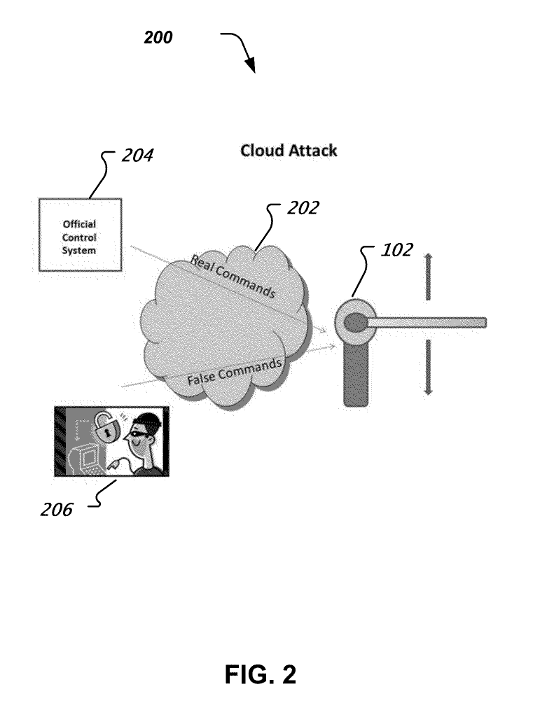

FIG. 2 depicts an example of a public access system 200 that is remotely controlled by a control system 204. The remote control system 204 may communicate with the access-restricting mechanism that lifts the bar 102 up or down from a remote location via a communication network 202. As cloud computing and the internet are becoming pervasive, public access systems can be connected, have an internet protocol (IP) address and an IP communication stack, and may be reachable from the internet. As a result, the control plane of the system 200 could become vulnerable to attack from a remote hacker 206 who may be able to communicate with the electronically actuated bar 102. For example, a remote hacker 206 could impersonate the official control system 204 and put the access devices such as the bar 102 in a blocked or open position at discretion. By putting security gates in a blocked position, the denial of entry to or exit from a public area like a parking garage by authorized personnel could be remotely accomplished by such a malicious attacker. As another example, a computer-savvy hacker could create an application on a mobile device that remotely commands the access gate 102 to open as desired, thereby allowing many user (who download and install this application on their mobile devices) to avoid having to pay for access. Because the hacker could be physically located at a remote location, locating where the hacker physically is and apprehending the hacker may not be easy or possible or worthwhile.

One of the operational challenges to securing communication between the remote controller 204 and the bar 102 is the cost of implementing security systems. For example, some public access systems generate a low amount of revenue on a per-transaction basis (e.g., 2 to 10 dollars per vehicle). Using encryption technology such as the Public Key Infrastructure (PKI), e.g., as is done in securing credit card transactions, may be a significant cost burden to a public access system operator. The use of PKI infrastructure often involves setting up business relationships with an encryption key issuing authority and with a key verification authority or a clearing house that authenticates online transactions. Such services often charge on a per-use basis. In general, the use of PKI may be expensive and could take away a significant amount of revenue generated by an operator of a public facility. Public access system operators would therefore prefer to deploy a less expensive yet secure solution.

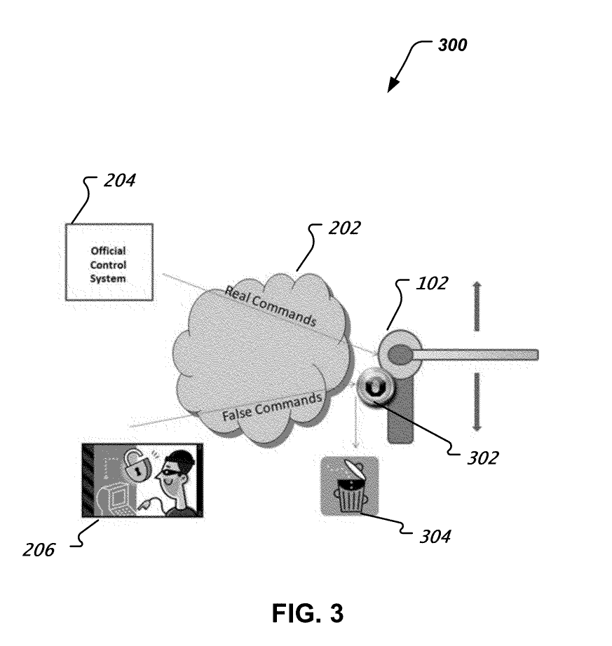

FIG. 3 shows an example of an access restricted system 300 under a control of a remote controller with an enhanced counter-attack capability. In some embodiments, a PKI-free asymmetric cryptography system could be added to the control plane of the public access system and used to verify the authenticity, verify integrity and obscure the discovery of the messages provided from the remote controller 204 to the access devices 102. This would allow the access device 102 to be sure that the control plane commands received via the cloud are indeed from an authentic source and have not been modified or tampered with by a hacker. In some embodiments, the control commands from the remote controller 204 could be encrypted to contain a nonce and/or a message number. In some embodiments, two sets of asymmetric keys may be used to help avoid brute strength attacks. In some embodiments, responses could also be encrypted and could contain the message number and nonce.

As illustrated in FIG. 3, in addition to one or more of the above features, the system 300 can be implemented to include an on-site module 302 at the access device or bar 102 which is used as a gate keeper to do an initial processing of a received command via the network 202. The on-site module 302 operates to determine whether a received command is false, or not authentic, before allowing the received command to be executed at the access device or bar 102. When the on-site module 302 determines that a particular received command is false or otherwise not authentic, the on-site module 302 will discard the particular received command (304) without performing an action commanded by the received command. The on-site module 302 can be implemented in various configurations, including a software module installed at a digital signal processor or microprocessor at the access device or bar 102, or a hardware module.

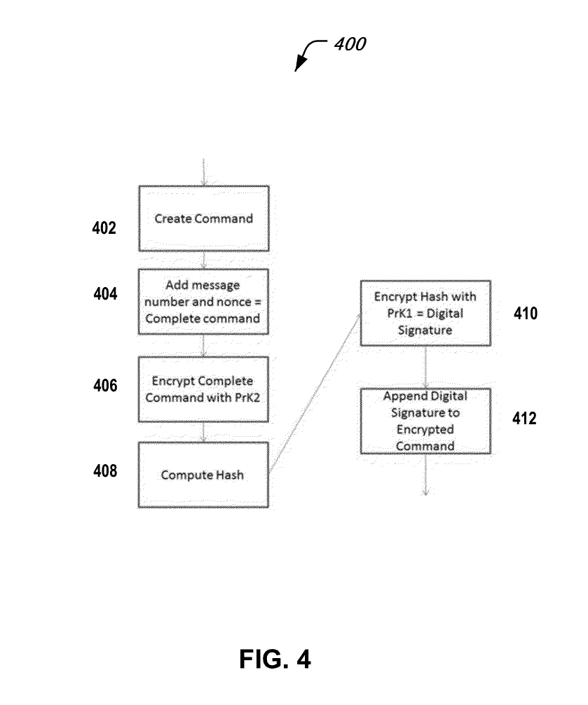

FIG. 4 is a flowchart depiction of an example of a method 400 implemented at the remote controller or control system 204 related to securing the commands to be sent to the access device 102.

At 402, the remote controller 204 creates a command in a format or protocol that is understood by the access device 102 at the access restricted premise or location.

At 404, the remote controller 204 adds a message number and a nonce (e.g., an arbitrary number used only once in a cryptographic communication) to the command. The message number may be used to cross-refer to any responses from the access device 102. The nonce may be included to strengthen the encryption against brute force attacks, as further explained in this document.

Typically, there are three elements to strengthening encryption: the cleartext to be encrypted, the encryption key and the encryption algorithm. A sophisticated hacker who gets possession of two out of the three elements may be able to calculate the third element. In public access systems, only a finite number of different messages may be exchanged between the control system 204 and the access device 102. For example, the messages may include directives such as “authenticate_request” to “authenticate_response” and may specify actions such as “gate open” and “gate close.” In other words, a sophisticated hacker may be able to capture a number of message transactions and make a reasonable estimate of the cleartext carried in the messages

In some embodiments, to avoid the calculation of the encryption key by a hacker, the cleartext that is transmitted is made different each time by addition of a message number and the nonce to avoid duplicate cleartext making brute force attacks harder. In one advantageous aspect, the user of a message number and the nonce can deter replay attacks.

At 406, the controller 204 encrypts the resulting cleartext plus message number and nonce. In some implementations, the encryption may be based on the use of a public key (for decryption) and a private key (for encryption) associated with the control system 204. The key used may be called private key 2 (PrK2). The key PrK2 may be known only to the controller 204 or the official control server 204 (and not the access device 102) and is not shared with an outside entity. In some embodiments, PrK2 may be used only for encryption of commands and not used for digital signature (described later) in order to avoid brute force discovery of PrK2.

At 408, the controller or control server 204 computes a hash of the encrypted message. The hashing algorithm used is known a priori both to the control server 204 and the access device 102.

At 410, the controller or control server 204 encrypts the hash calculated in 408 using the private key of a public-private key pair for the control server known as private key 1 (PrK1). The PrK1 is known only to the official control server 204 and is not shared. The PrK1 is used only for encryption of the hash and never used in the encryption of the commands in order to avoid brute force discovery of PrK1. The result of operation 410 called a digital signature of the transmission.

At 412, the controller or control server 204 associates the digital signature with the encrypted command as a message digest, e.g., by appending the digital signature to the encrypted command. The resulting data bits may be transmitted via a suitable protocol such as chat over the cloud to the device. For example, in some embodiments, the data bits may be transmitted as IP packets. In some embodiments, the data bits may be converted into a text message and transmitted as a short message service (SMS) text message.

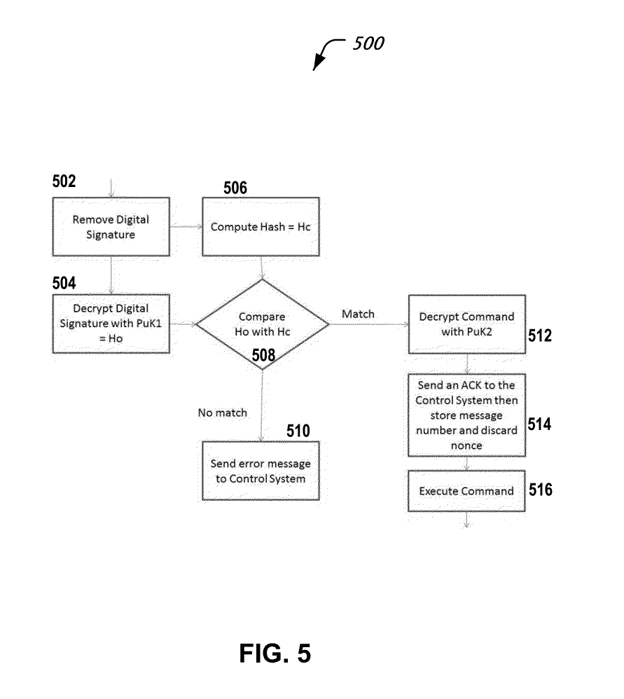

FIG. 5 is a flowchart representation of an example of a method 500 implemented at the access device 102 once a command is received in the form of the above-disclosed data bits.

At 502, the access device 102 separates the message digest containing the digital signature from the encrypted command.

At 504, the access device 102 decrypts the digital signature using the public key of a public-private key pair for the control server known as public key 1 (PuK1). The PuK1 may be known all of the access devices 102. The result of the calculation produces the original hash as computed by the control server.

At 506, the access device 102 calculates a hash of the encrypted command. The operations 504 and 506 may be done in any order or simultaneously because they do not depend on each other's results.

At 508, the access device 102 compares the original hash and the computed hash. If they match then method 500 performs the operation 512. If they do not match, then the access device 102 performs the operation 510.

At 510, the access device 102 may send an error message to the control server 204. Further, the access device 102 may hold the current state of the access device 102 (e.g., hold the access device in the open or the closed position).

At 512, the access device 102 may decrypt the command using the public key of a public-private key pair for the control server known as public key 2 (PuK2). The PuK2 may be known to all of the access devices. The result of the decryption operation 512 may include a cleartext version of the command, message number and nonce that were sent by the control system 204.

At 514, the access device 102 may generate and transmit an acknowledgement response back to the control server 204. The response may include the message number and the nonce for reference and variability of the response message, respectively. In some embodiments, the message may be encrypted by PuK2 for additional security. In some embodiments, upon receiving the response message, the control system 204 can use PrK1 to decrypt the acknowledgment response and alert an operator of any commands that do not have a proper response as this may indicate an outage or a cyber-attack. In some embodiments, the message number is stored by the access device 204 so that it is able to track what the next message number should be and avoid replay attacks. The nonce may be discarded.

At 516, the access device 102 may execute the command received in the message. The command received in the message may cause the access device 102 to activate (or deactivate) and electromechanical mechanism to unlock or move a physical barrier. The command may cause the access device 102 to perform diagnostic check-up of the system, and so on.

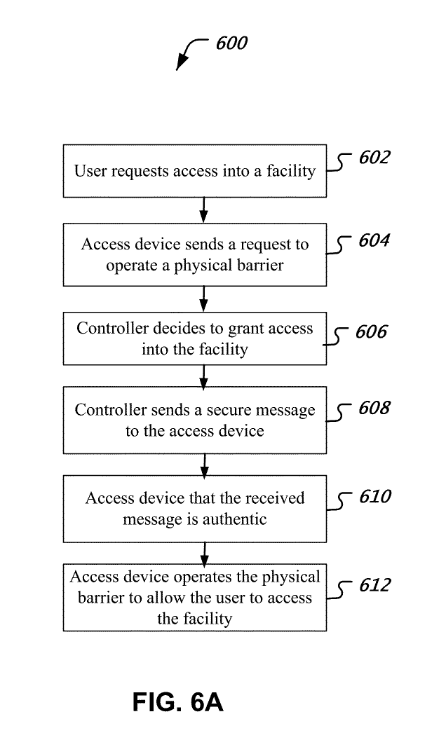

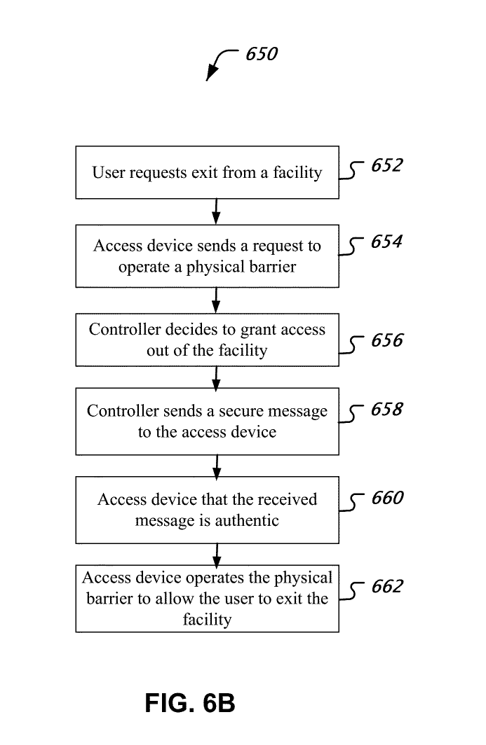

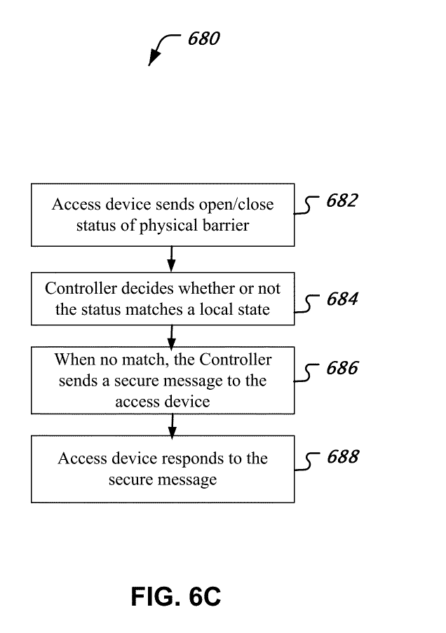

FIG. 6A shows an example of a workflow 600 for the operation of a facility. At 602, a user may request to access or enter into the facility (e.g., taking a ticket at a kiosk or by simply driving close to the entrance of a parking structure, which triggers automatic vehicle detection). At 604, the access device located at the facility sends a request to operate a physical barrier, such as a gate or a bar, to allow the requested access. The request may be sent to a remotely located controller, as previously disclosed, via a communication network. Based on the content of the request message, the controller may decide (606) whether or not to provide access. At 608, the controller may send a secure message via the communication network to the access device to operate (or not to operate) the physical barrier to the facility. At 610, the access device may perform message decryption operations (e.g., method 500) to decide whether or not the received message is authentic and can be relied upon for the operation. When the received message is authentic, at 612, the access device may perform the operation indicated in the message, e.g., lifting the physical barrier to allow the requester user to access the facility.

FIG. 6B depicts an example of a workflow 650 in which a user requests to exit from a facility (652). For example, a driver may be exiting a parking garage. At 654, the access device transmits a request to operate a physical barrier to allow the user to exit the facility. The request may be transmitted via the previously described communication network 202. At 656, the controller receives the request and makes a decision about the exit request. The controller may, e.g., verify whether or not correct payment was made. Based on the decision, at 658, the controller may send a secure message to the access device (e.g., encrypted using method 400). Upon reception of this message, the access device may verify that the received message is authentic (e.g., using method 500). When the received message is authentic, the access device may operate the physical barrier to allow the user to exit the facility.

FIG. 6C depicts an example of a workflow 680 in which an access device may provide periodic status messages to the controller. The workflow 680 may be triggered due to passage of time (e.g., once every five minutes) or may be polled from the controller via a status request. At 682, the access device may send a message, using the same message authentication mechanism as described with respect to method 500, to the controller whether the physical barrier is in an open state or in a closed state. Based on the past operation history, the controller may store a local state that the access device should be in. At 684, the controller may compare the received status to check whether or not the status matches the local state. If there is a mismatch, e.g., the physical barrier is in an open state when it should have been closed, the controller may transmit a secure message via the communication network 202, to correct the mismatch. This message may, e.g., instruct the access device to bring the physical barrier to the expected state or may instruct the access device to perform a system diagnosis to verify that the system is not malfunctioning. At 688, when the access device authenticates that the message is from the access controller (e.g., using method 500), the access device may perform the requested action.

Using the message security methods, e.g., as described with respect to FIG. 4 and FIG. 5, the above-described workflows 600, 650 and 680 can thus be made secure to spoofing and/or hacking attacks.

FIG. 700 is a flowchart depiction of an example of a method 700 for securing a communication between the controller 204 and the access mechanism 102. At 702, the method 700 generates a command. The command may be generated in response to, e.g., messages 602, 652 or 682. The command may specify an action to be performed by an access mechanism to the facility (e.g., open, close, run a diagnostic check, etc.). At 704, the method 700 produces a complete command by adding a message number and a nonce to the command, e.g., as described with respect to FIG. 4. At 706, the method 700 generates an encrypted complete command by encrypting the complete command using a first private key. In some embodiments, the private key may be a 64 bit or a 128 bit key. At 708, the method 700 computes a hash of the encrypted complete command. At 710, the method 700 calculates a digital signature by encrypting the hash using a second private key. At 712, the method may transmit the encrypted complete command and the digital signature using a transmission protocol.

In some embodiments, an apparatus for controlling access to a facility includes a module (e.g., a network interface) for receiving a request message and transmit a response message over a communication network, a module (e.g., a decision module) for deciding, based on the request message, an operation to be performed on a physical barrier, and a module (e.g., an encryption module) for encrypting an operation command indicative of the operation to be performed on the physical barrier into the response message. The apparatus may encrypt a first portion of the response message using a first encryption key and a second portion of the response message using a second encryption key, e.g., as previously disclosed with respect to method 400.

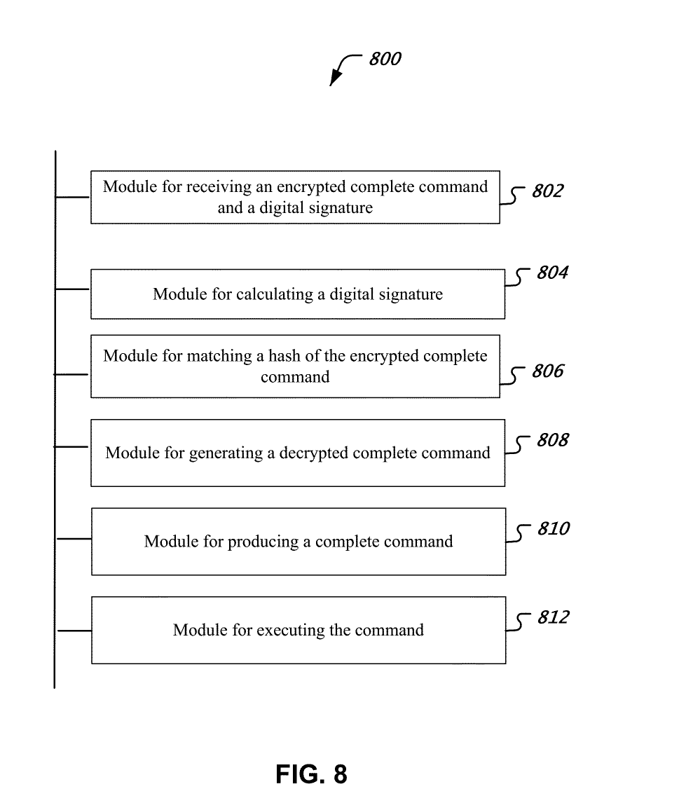

FIG. 8 is a block diagram representation of an example of apparatus 800 for controlling access to a facility. The module 802 (e.g., a network module) is for receiving an encrypted complete command and a digital signature. The module 804 (e.g., a signature verification module) is for calculating a digital signature by decrypting the encrypted complete command using a first public key. The module 806 (e.g., a hash matching module) is for matching a hash of the encrypted complete command. The module 808 (e.g., a decryption module) is for generating a decrypted complete command by decrypting the complete command using a second public key. The module 810 (e.g., a message filter module) is for producing a complete command by removing a message number and a nonce to the command. The module 812 (e.g., a command execution module) is for executing the command, wherein the command specifies an action to be performed by an access mechanism to the facility. In some embodiments, the apparatus 800 may further include an acknowledgement module that generates an acknowledgement message and includes a response code in the acknowledgement message. In some embodiments, the transmission protocol may comprise the SMS protocol and the network module may include a text reception module that receives the text message and a translation module that translates the text message into the encrypted complete command and the digital signature. In some embodiments, the apparatus 800 further includes a first activation module that activates, when a command to open access is received, the access mechanism to allow access in and out of the facility and a second activation unit that activates, when a command to close access is received, the access mechanism to disallow access in and out of the facility.

In some embodiments, a method of controlling access to a facility includes receiving an encrypted complete command and a digital signature, calculating a digital signature by decrypting the encrypted complete command using a first public key, matching a hash of the encrypted complete command, generating a decrypted complete command by decrypting the complete command using a second public key, producing a complete command by removing a message number and a nonce to the command, and executing the command, wherein the command specifies an action to be performed by an access mechanism to the facility. In some embodiments the method further includes generating an acknowledgement message and including a response code in the acknowledgement message.

In some embodiments, the transmission protocol includes a simple messaging system (SMS) protocol. The receiving operation includes receiving the text message using the SMS protocol and converting the text message into the encrypted complete command and the digital signature. In some embodiments, when the matching of the hash of the encrypted complete command fails (e.g., results do not match with expected hash results), the received command is discarded and no change is made to the access mechanism, e.g., access mechanism remains in its position.

In some embodiments, a system for securing access to a facility includes an access device that operates a physical barrier that controls access to the facility and a controller that is located remotely from the access device and controls operation of the access device by transmitting operation commands to the access device. The controller transmits an operation command by encrypting a command code by a first private key, calculating a hash value of the encrypted command code, signing the hash value by a second private key; and including the encrypted command code and the signed hash value in the transmission. The access device receives the transmission, extracts the operation command, and upon successful extraction of the operation command, operates the physical barrier according to the operation command.

It will be appreciated that techniques for securing communication messages that control the operation of a physical barrier controlling access to a facility are disclosed. In some embodiments, the message security is accomplished without using public key infrastructure such as a certification authority. In one advantageous aspect, two different private keys can be used to encrypt transmitted messages—a first private key could be used for privacy reason—i.e., deterring unauthorized listeners from receiving and deciphering the message, and a second private key for calculating a hash of the encrypted message, thereby providing information to a receiver for ascertaining the validity of a received message.

The disclosed and other embodiments, the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of controlling access to a facility, comprising:
generating a command, wherein the command specifies an action to be performed by an access mechanism to the facility;
producing a complete command by adding a message number and a nonce to the command;
generating an encrypted complete command by encrypting the complete command using a first private key;
computing a hash of the encrypted complete command;
producing a digital signature by encrypting the hash using a second private key; and
transmitting the encrypted complete command and the digital signature using a transmission protocol.

2. A method of claim 1 further comprising:
receiving an acknowledgement message; and
recovering a response code from the acknowledgement message.

3. The method of claim 2, further including:
generating a user alert upon determining that the response code is indicate of an error condition.

4. The method of claim 1, wherein the transmission protocol includes a Short Message System (SMS) protocol and wherein the transmitting operation includes:
converting the encrypted complete command and the digital signature into a text message; and
transmitting the text message using the SMS protocol.

5. An apparatus for controlling access to a facility, comprising:
a network interface to receive a request message and transmit a response message over a communication network;
a decision module to decide, based on the request message, an operation to be performed on a physical barrier, and
an encryption module to encrypt an operation command indicative of the operation to be performed on the physical barrier into the response message, wherein a first portion of the response message is encrypted using a first encryption key and a second portion of the response message is encrypted using a second encryption key.

6. The apparatus of claim 5, wherein the first portion of the response message includes a representation of the operation command and the second portion of the response message includes a hash value.

7. The apparatus of claim 5, wherein the first encryption key is a first private key of a first public/private key pair and the second encryption key is a second private key of a second public/private key pair.

8. The apparatus of claim 5, wherein the network interface includes a wireless cellular interface.

9. The apparatus of claim 5, further including:
an error processing module that generates an operator alert when the request message indicates an error condition.

10. A method of controlling access to a facility, comprising:
receiving an encrypted complete command and a digital signature;
calculating a digital signature by decrypting the encrypted complete command using a first public key;
matching a hash of the encrypted complete command;
generating a decrypted complete command by decrypting the complete command using a second public key;
producing a complete command by removing a message number and a nonce to the command; and
executing the command, wherein the command specifies an action to be performed by an access mechanism to the facility.

11. The method of claim 10 further comprising:
generating an acknowledgement message; and
including a response code in the acknowledgement message.

12. The method of claim 10, wherein the transmission protocol includes a simple messaging system (SMS) protocol and wherein the receiving operation includes:
receiving the text message using the SMS protocol; and
converting the text message into the encrypted complete command and the digital signature.

13. The method of claim 10, further comprising:
activating, when a command to open access is received, the access mechanism to allow access in and out of the facility; and
activating, when a command to close access is received, the access mechanism to disallow access in and out of the facility.

14. The method of claim 10, further comprising:
discarding, when the matching the hash of the encrypted complete command fails, the received complete command.

15. An apparatus for controlling access to a facility, comprising:
a network module that receives an encrypted complete command and a digital signature;
a signature verification module that calculates a digital signature by decrypting the encrypted complete command using a first public key;
a hash matching module that matches a hash of the encrypted complete command;
a decryption module that generates a decrypted complete command by decrypting the complete command using a second public key;
a message filter module that produces a complete command by removing a message number and a nonce to the command; and
a command execution module that executes the command, wherein the command specifies an action to be performed by an access mechanism to the facility.

16. The apparatus of claim 15, further comprising:
an acknowledgement module that generates an acknowledgement message and includes a response code in the acknowledgement message.

17. The apparatus of claim 15, wherein the transmission protocol includes a Short Message System (SMS) protocol and wherein the network module includes:
a text reception module that receives the text message; and
a translation module that translates the text message into the encrypted complete command and the digital signature.

18. The apparatus of claim 15, further comprising:
a first activation module that activates, when a command to open access is received, the access mechanism to allow access in and out of the facility; and
a second activation unit that activates, when a command to close access is received, the access mechanism to disallow access in and out of the facility.

19. The apparatus of claim 15, wherein, the apparatus controls the command execution module to refrain from executing the command when the hash of the encrypted command does not match or the decrypting the complete command fails.

20. A system for securing access to a facility comprising:
an access device that operates a physical barrier that controls access to the facility; and
a controller that is located remotely from the access device and controls operation of the access device by transmitting operation commands to the access device;
wherein the controller transmits an operation command by encrypting a command code by a first private key, calculating a hash value of the encrypted command code, signing the hash value by a second private key and including the encrypted command code and the signed hash value in the transmission; and
wherein the access device receives the transmission, extracts the operation command, and upon successful extraction of the operation command, operates the physical barrier according to the operation command.

21. The system of claim 20, wherein the controller transmits the operation command and the access device extracts the operation command without using a public key infrastructure and a certificate authority.

22. The system of claim 20, wherein the controller transmits the operation command using a Short Message Service (SMS) protocol of a wireless cellular network.
